(19) United States
(12) Patent Application Publication
(10) Pub. No.: US 2026/0059449 A1
(43) Pub. Date: Feb. 26, 2026

(54) CELL RE-SELECTION ENHANCEMENTS

(71) Applicant: Nokia Technologies Oy, Espoo (FI)

(72) Inventors: Samuli Heikki TURTINEN, Oulu (FI); Chunli WU, Beijing (CN); Jussi-Pekka KOSKINEN, Oulu (FI)

(21) Appl. No.: 19/104,267

(22) PCT Filed: Aug. 17, 2022
(86) PCT No.: PCT/CN2022/113118

§ 371 Date: Feb. 17, 2025

(51) Int. Cl. H04W 52/02; H04W 48/20

(52) U.S. Cl. CPC H04W 52/0235; H04W 48/20

(57) ABSTRACT

Example embodiments of the present disclosure relate to devices, methods, apparatuses and computer readable storage media for cell re-selection enhancements. A first device receives, from a second device providing a source cell, cell re-selection information indicating a set of candidate cells or candidate frequencies for cell re-selection. The first device receives, from the second device, assistance information for cell re-selection indicating at least one frequency or at least one neighbor cell applying a wake-up signal (WU'S), and the set of candidate cells or candidate frequencies comprises at least one neighbor cell or the at least one frequency. The first device performs, based on the cell re-selection information and the assistance information, a cell re-selection evaluation on at least a part of the set of candidate cells or candidate frequencies. In this way. UE supporting WUS can prioritize cells or frequencies that apply WUS, thus energy efficiency can be improved.

### FIELD

Embodiments of the present disclosure generally relate to the field of telecommunication and in particular, to devices, methods, apparatus and computer readable storage media for cell re-selection enhancements.

### BACKGROUND

UE energy efficiency is critical to the 5G system, Currently, 5G devices may have to be recharged per week or per day, which depend on individual's usage time. In general, 5G devices consume tens of milliwatts in RRC_IDLE state or RRC_INACTIVE state, and hundreds of milliwatts in RRC_CONNECTED state. Moreover, energy efficiency is even more critical for UEs without a continuous energy source, for example, UEs using small rechargeable and single coin cell batteries. For improving energy efficiency as well as for a better user experience, there is a trend to prolong battery life and reduce power consumption of terminal devices.

### SUMMARY

In general, example embodiments of the present disclosure provide a solution of cell re-selection enhancements.

In a first aspect, there is provided a first device. The first device comprises at least one processor; and at least one memory storing instructions that, when executed by the at least one processor, cause the first device at least to perform: receiving, from a second device providing a source cell for the first device, cell re-selection information indicating a set of candidate cells or candidate frequencies for cell re-selection; receiving, from the second device, assistance information for cell re-selection, the assistance information indicating at least one frequency or at least one neighbor cell applying a wake-up signal, the set of candidate cells or candidate frequencies comprising the at least one neighbor cell or the at least one frequency; and performing, based on the cell re-selection information and the assistance information, a cell re-selection evaluation on at least a part of the set of candidate cells or candidate frequencies.

In a second aspect, there is provided a second device. The second device comprises at least one processor; and at least one memory storing instructions that, when executed by the at least one processor, cause the second device at least to perform: obtaining at least one indication of at least one frequency or at least one neighbor cell applying a wake-up signal; transmitting, to a first device in a source cell provided by the second device, cell re-selection information indicating a set of candidate cells or candidate frequencies for cell re-selection; and transmitting, to the first device, assistance information for cell re-selection, the assistance information indicating the at least one frequency or the at least one neighbor cell, the set of candidate cells or candidate frequencies comprising at least one neighbor cell or the at least one frequency.

In a third aspect, there is provided a method. The method comprises: receiving, at a first device and from a second device providing a source cell for the first device, cell re-selection information indicating a set of candidate cells or candidate frequencies for cell re-selection; receiving, from the second device, assistance information for cell re-selection, the assistance information indicating at least one frequency or at least one neighbor cell applying a wake-up signal, the set of candidate cells or candidate frequencies comprising at least one neighbor cell or the at least one frequency; and performing, based on the cell re-selection information and the assistance information, a cell re-selection evaluation on at least a part of the set of candidate cells or candidate frequencies.

In a fourth aspect, there is provided a method. The method comprises: obtaining, at a second device, at least one indication of at least one frequency or at least one neighbor cell applying a wake-up signal; transmitting, to a first device in a source cell provided by the second device, cell re-selection information indicating a set of candidate cells or candidate frequencies for cell re-selection; and transmitting, to the first device, assistance information for cell re-selection, the assistance information indicating the at least one frequency or the at least one neighbor cell, the set of candidate cells or candidate frequencies comprising at least one neighbor cell or the at least one frequency.

In a fifth aspect, there is provided a first apparatus. The first apparatus comprises: means for receiving, from a second apparatus providing a source cell for the first apparatus, cell re-selection information indicating a set of candidate cells or candidate frequencies for cell re-selection; means for receiving, from the second apparatus, assistance information for cell re-selection, the assistance information indicating at least one frequency or at least one neighbor cell applying a wake-up signal, the set of candidate cells or candidate frequencies comprising at least one neighbor cell or the at least one frequency; and means for performing, based on the cell re-selection information and the assistance information, a cell re-selection evaluation on at least a part of the set of candidate cells or candidate frequencies.

In a sixth aspect, there is provided a second apparatus. The second apparatus comprises: means for obtaining at least one indication of at least one frequency or at least one neighbor cell applying a wake-up signal; means for transmitting, to a first apparatus in a source cell provided by the second apparatus, cell re-selection information indicating a set of candidate cells or candidate frequencies for cell re-selection; and means for transmitting, to the first apparatus, assistance information for cell re-selection, the assistance information indicating the at least one frequency or the at least one neighbor cell, the set of candidate cells or candidate frequencies comprising at least one neighbor cell or the at least one frequency.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication environment in which example embodiments of the present disclosure can be implemented;

FIGS. 2A-2B illustrate example operations of UE supporting the wake-up signal (WUS) according to some example embodiments of the present disclosure;

FIG. 3 illustrates a flowchart of a process for cell re-selection according to some example embodiments of the present disclosure;

FIG. 4 illustrates a flowchart of an example method according to some example embodiments of the present disclosure;

FIG. 5 illustrates a flowchart of another example method according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements> and “at least one of <a list of two or more elements> and similar wording, where the list of two or more elements are joined by “and” or “or”, means at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a Next Generation NodeB (NR NB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

### Example Environment

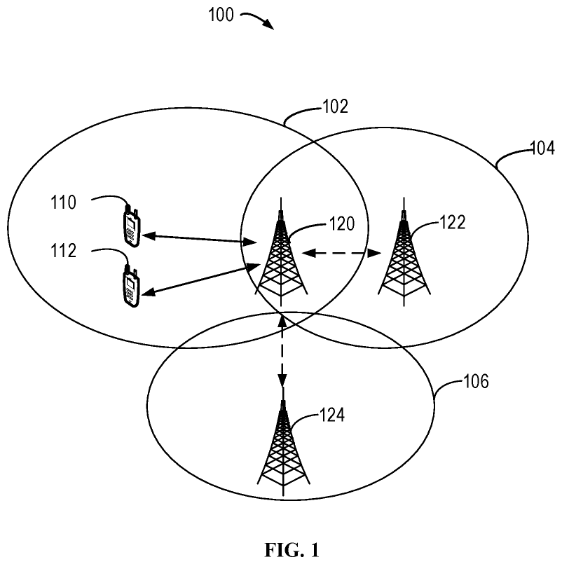

FIG. 1 illustrates an example communication environment 100 in which example embodiments of the present disclosure can be implemented. As shown in FIG. 1, the communication environment 100 may include a first device 110, a second device 120, a plurality of third devices 122 and 124, and a fourth device 112. The first device 110 and the fourth device 120 may be terminal devices (e.g., UEs), hereinafter which may be also referred to as UE 110 or UE 140. The second device 120 and the plurality of third devices 130 may be network devices (e.g., gNBs). The second device 120, the plurality of third devices 112 and 114 each provide cells 102, 104 and 106.

In the example of FIG. 1, the first device 110 and the fourth device 112 are camped on the cell 102. Accordingly, the first device 110 and the fourth device 112 can communicate with the second device 120. Hereinafter, the cell 102 may be also referred to as the source cell 102 or the serving cell 102. The third devices 122 and 124 acts as neighbor base stations, Accordingly, the cells 104 and 106 may be also referred to as neighbor cells 104 and 106. The second device 120 and the third devices 122 and 124 may communicate with each other.

In a case where the first device 110 or the fourth device 112 is in RRC_IDLE state or RRC-INACTIVE state, a cell re-selection procedure may be performed. The second device 120 may broadcast cell re-selection information, for example, in a system information block (SIB). The first device 110 or the fourth device 112 may measure attributes of the serving cell and neighbor cells to initiate the reselection process. For the search and measurement of inter-frequency neighboring cells, the second device 120 may need to indicate carrier frequencies. During the cell re-selection procedure, the first device 110 or the fourth device 112 may identify a cell (i.e., a target cell) to be camped on based on cell reselection criteria. The cell reselection criteria mainly involve measurements of the serving and neighbor cells as below:
Intra-frequency reselection is based on ranking of cells;
Inter-frequency reselection is based on absolute priorities where a UE tries to camp on the highest priority frequency available.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in any of the cells 102 to 106, and one or more additional cells may be deployed in the communication environment 100.

It is also noted that although illustrated as a network device, the second device 120 and the third devices 122 and 124 may be other devices than network devices. Although illustrated as terminal devices, the first device 110 and the fourth device 140 may be other devices than terminal devices. In the following, for the purpose of illustration, some example embodiments are described with the first device 110 and the fourth device 140 operating as terminal devices and the second device 120 as well as the third devices 122 and 124 operating as network devices. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the network system, power consumption of UE depends on a configured length of wake-up periods, e.g., a paging cycle. In order to reduce the power consumption, extended Discontinuous Reception (eDRX) cycle with a large value is expected to be used, which may result in a high latency, and is not suitable for such services with requirements of both long battery life and low latency. Thus, ultra-low power mechanism that can support low latency, e.g., lower than the eDRX latency is needed. Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal (WUS) to trigger the main radio and a separate receiver which has the ability to monitor wake-up signal with ultra-low power consumption. Main radio works for data transmission and reception, which can be turned off or set to deep sleep unless it is turned on. The power consumption for monitoring wake-up signal depends on the WUS design and the hardware module of the wake-up receiver used for signal detecting and processing.

However, WUS may not be provided by the network in every cell or every frequency. This may affect the normal communication and usage of the UE. For example, a UE supporting WUS may not know which cell or frequency also supports WUS. As a result, the UE may not be able to take advantage on the WUS provided by different cells, e.g., in cell re-selection.

### Work Principle and Example Signaling for Communication

According to some example embodiments of the present disclosure, there is provided a solution for cell re-selection enhancements. In this solution, the UE receives cell re-selection information indicating a set of candidate cells or candidate frequencies for cell re-selection from a gNB providing a source cell for the UE. The UE receives assistance information for cell re-selection from the gNB, which indicates at least one frequency or at least one neighbor cell applying a wake-up signal, the set of candidate cells or candidate frequencies comprising the at least one neighbor cell or the at least one frequency. Accordingly, the UE may perform a cell re-selection evaluation on at least a part of the set of candidate cells or candidate frequencies based on the cell re-selection information and the assistance information. In this way, the gNB is able to direct the UEs supporting WUS to a proper cell or frequency applying the WUS. As such, the power consumption is reduced, while the latency and mobility performance are ensured.

Example embodiments of the present disclosure will be described in detail below with reference to the accompanying drawings.

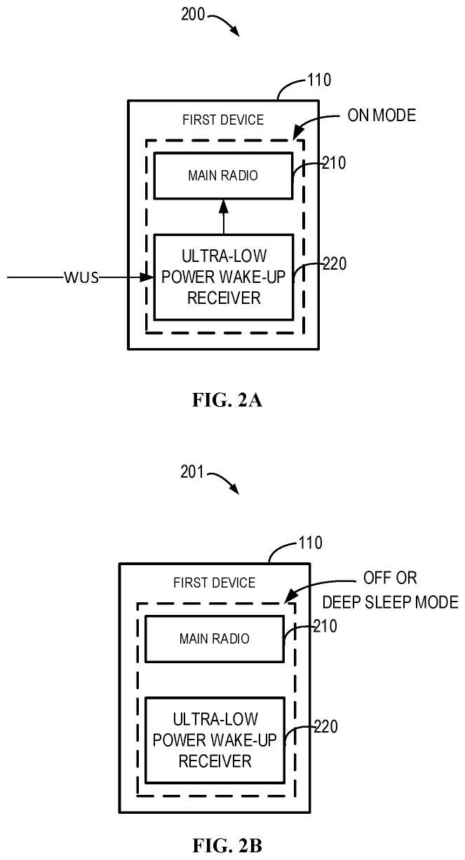

FIGS. 2A-2B illustrate example operations 200 and 201 of UE supporting the WUS according to some example embodiments of the present disclosure. The UE supporting WUS may be, for example, the first device 110 as shown in FIG. 1. In addition, in the example of FIG. 1, the fourth device 140 may be a normal UE that does not support WUS.

The first device 110 is equipped with the main radio 210 and a separate ultra-low power wake-up receiver 220 (which may be also referred to as WUR 220 hereinafter). The main radio 210 may be a NR transceiver that may operate in a sleep mode, or sometimes even be powered off for power saving purpose. In some example embodiments, the main radio 210 may be activated only upon reception of the WUS from serving cell 102. For example, the second device 120 may trigger the first device 110 to wake-up in an event-driven manner. In this case, the second device 120 may transmit a special WUS to the first device 110, which is monitored by the WUR 220.

As shown in FIG. 2A, if the WUR 220 receives the WUS, the WUR 220 may trigger the wake-up of the main radio 210 and communication can start. Otherwise, the main radio 210 is in OFF mode or kept in a deep sleep mode, as shown in FIG. 2B. In some example embodiments, the WUR 220 may operate in an always ‘on’ manner with very low power consumption. Since WUR is only able to receive WUS, it is possible that the WUR 220 will consume significantly less power compared to the main radio 210.

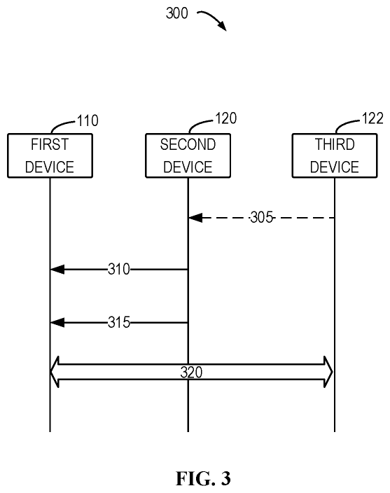

Reference is now made to FIG. 3, which illustrates a flowchart of a process 300 for cell re-selection according to some example embodiments of the present disclosure. As shown in FIG. 3, the process 300 involves at least the first device 110, the second device 120 and the third device 122. For the purpose of discussion, reference is made to FIG. 1 to describe the signaling chart 300. Although the first device 110, the second device 120 and the third device 122 are illustrated in FIG. 3, it would be appreciated that there may be a plurality of terminal devices performing similar operations as described with respect to the first device 110 below and a plurality of network device performing similar operations as described with respect to the second device 120 or the third device 122 below.

In the communication network 100, the cells 102 to 106 and corresponding frequencies may differ from applying WUS or not. As previously mentioned, the second device 120, served as a source base station, may broadcast cell re-selection information in the cell 102, for example, via SIB. In order to facilitate the cell re-selection procedure and taking different link budget for WUS into account, the second device 120 may obtain 305 at least one indication of at least one frequency or at least one neighbor cell applying the WUS. Alternatively, the second device 120 may obtain such an indication from any other network device in RAN.

The second device 120 transmits 310 cell re-selection information indicating a set of candidate cells or candidate frequencies for cell re-selection. The cell re-selection information may be carried in a network broadcast information, for example, the SIB.

In the example of FIG. 1, the set of candidate cells or candidate frequencies may include the cells 104 and 106 as well as their corresponding frequencies. In some example embodiments, the cell re-selection information may indicate a set of cell re-selection priorities of the set of candidate cells or candidate frequencies.

The second device 120 transmits 315 assistance information for cell re-selection, the assistance information indicating the at least one frequency or the at least one neighbor cell. The set of candidate cells or candidate frequencies comprising at least one neighbor cell or the at least one frequency. In the example of FIG. 1, the neighbor cell 104 and/or the corresponding frequency applies WUS.

The first device 110 performs 320 the cell re-selection evaluation on at least a part of the set of candidate cells or candidate frequencies based on the cell re-selection information and the assistance information. For example, the first device 110 may perform measurements on at least a part of the set of candidate cells or candidate frequencies. For example, the first device 110 may compare the measurements and/or measurement results on at least a part of the set of candidate cells or candidate frequencies to the measurements and/or measurement results of other cells or frequencies, for instance, serving cell, intra-/inter-frequency, set of cells not part of the set of candidate cells, and/or set of frequencies not part of the set of candidate frequencies.

In some example embodiments, the assistance information may be carried via a dedicated signaling, e.g., a radio resource control (RRC) message. For example, the assistance information may be carried in a RRC release message in a case where the first device 110 is directed to RRC_IDLE mode or RRC_INACTIVE mode.

Alternatively, in some example embodiments, the assistance information may be carried in the network broadcast information, for example, the SIB. For example, an existing SIB may be reused for carrying the assistance information. For another example, a new SIB may be used for specifically carrying the assistance information. Therefore, the scope of the present disclosure is not limited in this regard.

In some example embodiments, the assistance information may be in a form of a cell list or frequency list that applies WUS. In the example of FIG. 1, the assistance information may indicate the cell 104 or its corresponding frequency.

In some example embodiments, assistance information for cell re-selection carried in dedicated signaling may be prioritized over assistance information for cell re-selection carried in a broadcast signaling. In this case, the first device 110 may perform the cell re-selection evaluation based on assistance information via the dedicated signaling while ignoring the assistance information via the broadcast signaling.

In some example embodiments, assistance information for cell re-selection carried in the broadcast signaling may be prioritized over assistance information for cell re-selection carried in the dedicated signaling. In this case, the first device 110 may perform the cell re-selection evaluation based on the assistance information via the broadcast signaling while ignoring the information via the dedicated signaling.

In some example embodiments, assistance information for cell re-selection carried in the dedicated signaling may be prioritized only in a cell which was a primary cell of the first device 110 in a case where the first device 110 is directed to RRC_IDLE mode or RRC_INACTIVE mode. Otherwise, assistance information for cell re-selection carried in the broadcast signaling may be prioritized.

In some example embodiments, the second device 120 may provide different assistance information to different terminal devices. For example, the assistance information may be associated with public land mobile network (PLMN). In other words, the assistance information may be provided specific to PLMN.

In some example embodiments, the first device 110 may determine priorities of the set of candidate cells or candidate frequencies based on at least one of the cell re-selection information and the assistance information. In particular, the first device 110 supporting WUS may rank the frequency applying WUS with a higher priority than any other frequency not applying WUS. For example, the frequency corresponding to cell 104 may be ranked as the highest priority for cell re-selection.

In some example embodiments, the assistance information may comprise separate absolute priorities for frequencies applying WUS. These absolute priorities may be applied by only the UE supporting WUS, i.e., the first device 120. Furthermore, the UE supporting WUS may ignore legacy absolute priorities of the frequencies for which absolute priorities for WUS are provided.

Additionally, or alternatively, in some example embodiments, the first device 110 may apply at least one offset priority to the absolute priorities of each frequency applying WUS as indicated by the assistance information. By way of example, in a case a frequency supports WUS, the first device 110 may determine a target priority of the frequency by increasing an absolute priority value of that frequency by the offset priority, such as, one, two, etc. In other words, the priority for a frequency supporting WUS could be different for the UEs supporting WUS and UEs not supporting WUS.

In some example embodiments, an offset value for cell ranking is applied by the first device 110 for at least one frequency where WUS is supported. The offset value may include but not limited to, Reference Signal Received Power (RSRP), Reference Signal Received Quality (RSRQ), Signal to Interference plus Noise Ratio (SINR), offset or multiple of those etc.

In some example embodiments, a cell quality threshold for cell reselection (e.g., Qrxlevmin) may be adjusted based on the offset value. For example, the first device 110 may increase or decrease by the offset value.

In some example embodiments, the cell quality may be adjusted based on the offset value. For example, the offset value may be used to regard the cell quality used for cell re-selection to be the et value better or worse than the measured cell quality.

In some example embodiments, the offset value may be provided by the second device 120, e.g., through broadcast signaling (e.g., SIB) or dedicated signaling (e.g., RRC).

In some example embodiments, the offset value may be provided specific to frequency or cell. Alternatively, or additionally, the offset value may be provided commonly for each cell supporting WUS.

In some example embodiments, the offset value may be predetermined at the first device 110 and the second device 120. For example, the offset value may be preconfigured by the second device 120, or alternatively, specified in relevant standards. In this way, the UE may determine that the at least one frequency or the at least one neighbor cell applying the WUS based on the assistance information. The UE may then apply the at least one offset value for cell re-selection

In some example embodiments, in a case where the first device 110 that supporting the WUS camps on a serving cell supporting WUS (e.g., the cell 102), a threshold for the first device 110 to start performing intra-frequency or inter-frequency measurement for cell re-selection may be different for the fourth device 140 not supporting WUS, since the link budget may be different for WUS than for any other signaling.

In some example embodiments, the assistance information may correspond to a device type of the first device 110. For example, the device type may comprise one of a RedCap device, or a non-RedCap device. In this case, the gNB may provide different assistance information to different types of UEs.

According to the example embodiments of the present disclosure, information of at least one frequency or at least one neighbor cell that applies WUS can be provided to UEs. This information assists the UEs supporting WUS in the cell re-selection evaluation. Such information would not affect cell re-selection principles of the UEs not supporting WUS. In this way, the energy efficiency in UE can be improved. In addition, mobility performance is ensured by taking different link budgets for WUS into account.

It should be understood that some of the steps in process 300 is optional or can be omitted, and the order of the steps is given for an illustrative purpose. Additionally, some of the steps may be performed in parallel with other steps. Thus, the embodiments of the present disclosure are not limited in this regard.

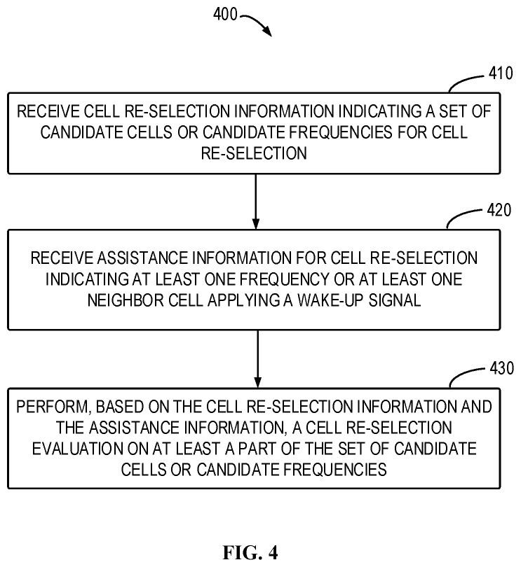

FIG. 4 illustrates a flowchart of an example method 400 according to some example embodiments of the present disclosure. The method 400 can be implemented at a terminal device, for example, the first device 110 described with reference to FIG. 1. For the purpose of discussion, the method 400 will be described with reference to FIG. 1. However, in some other embodiments, the method 400 can also be implemented at any other device, for example, a network device, such as, a gNB, a CU, DU, or so on. Therefore, the scope of the present disclosure is not limited in this regard.

At 410, the first device 110 receives, from a second device 120 providing a source cell 102 for the first device 110, cell re-selection information indicating a set of candidate cells or candidate frequencies for cell re-selection. In the example of FIG. 1, the candidate cells may include cells 104 and 106, and candidate frequencies may include at least one frequency at which cells 104 and 106 operate.

At 420, the first device 110 receives, from the second device 120, assistance information for cell re-selection. In this case, the assistance information indicates at least one frequency or at least one neighbor cell applying a WUS, and the set of candidate cells or candidate frequencies comprises the at least one neighbor cell or the at least one frequency.

In some example embodiments, the assistance information may be carried via at least one of the following: a SIB or a RRC message, such as a RRC release message. For example, an existing SIB may be reused for carrying the assistance information. For another example, a new SIB may be used for specifically carrying the assistance information. Therefore, the scope of the present disclosure is not limited in this regard.

In some example embodiments, the assistance information may comprise at least one of the following: a cell list comprising the at least one cell applying the WUS, or a frequency list comprising the at least one frequency applying the WUS.

In some example embodiments, the cell re-selection information may be carried in an SIB. Additionally, or alternatively, the assistance information may be carried in a RRC message. In other words, the cell re-selection information may be broadcast in cell 102, while the assistance information may be provided to UE via dedicated signaling.

At 430, the first device 110 performs, based on the cell re-selection information and the assistance information, a cell re-selection evaluation on at least a part of the set of candidate cells or candidate frequencies.

In some example embodiments where the cell re-selection information is carried in the SIB, and the assistance information is carried in the RRC message, the first device 110 may determine that information carried via the RRC message is prioritized over information carried via the SIB. Based on this determination, the first device 110 may perform the cell re-selection evaluation based on the assistance information. In this case, the first device 110 may ignore the information carried in the SIB.

Additionally, or alternatively, in some example embodiments where the cell re-selection information is carried in the SIB, and the assistance information is carried in the RRC message, the first device 110 may determine that information carried via the SIB is prioritized over information carried via the RRC message. Likewise, based on this determination, the first device 110 may perform the cell re-selection evaluation based on the cell re-selection information. In this case, the first device 110 may ignore the information carried in the RRC message.

In some example embodiments, the first device 110 may determine that the source cell 102 was a PCell before the first device 110 was directed to an RRC_INACTIVE mode or an RRC_IDLE mode. Based on determining that the source cell 102 was the PCell, the first device 110 may perform the cell re-selection evaluation based on the assistance information. Additionally, or alternatively, the first device 110 may determine that the source cell 102 was a cell other than a PCell. Based on determining that the source cell 102 was not the PCell, the first device 110 may perform the cell re-selection evaluation based on the cell re-selection information.

In other words, the assistance information via the dedicated signaling may be prioritized only in the cell which was the UE's PCell in a case where the first device 110 is directed to RRC_IDLE mode or RRC_INACTIVE mode. Otherwise, the cell re-selection information via the broadcast signaling will be prioritized.

In some example embodiments, the assistance information may be associated with at least one PLMN. That is, for UEs associated with different PLMN, different assistance information may be provided.

In some example embodiments, the first device 110 may determine, based on at least one of the cell re-selection information and the assistance information, priorities of the set of candidate cells or candidate frequencies.

In some example embodiments, the first device 110 may rank the at least one frequency or the at least one neighbor cell (i.e., 104) that applies the WUS with a higher priority than a rest of the set of candidate cells or candidate frequencies not applying the WUS, e.g., the cell 106 in this example.

In some example embodiments, the cell re-selection information may indicate a set of cell re-selection priorities assigned for a device not supporting the WUS, while the assistance information may indicate at least one cell re-selection priority assigned for at least one frequency or the at least one neighbor cell applying the WUS.

Additionally, in some example embodiments, the first device 110 may determine that the first device 110 supports the WUS or has a capability of processing WUS. Based on the determination that the first device 110 supports the WUS, the first device 110 may determine the priorities of the set of candidate cells or candidate frequencies based on the cell re-selection information.

In some example embodiments, the cell re-selection information may indicate a set of cell re-selection priorities of the set of candidate cells or candidate frequencies, and the assistance information may indicate at least one priority offset of the at least one frequency or at least one neighbor cell applying the WUS.

Additionally, in some example embodiments, the first device 110 may determine the first device 110 supports the WUS. Based on determining that the first device 110 supports the WUS, the first device 110 may determine the priorities of the set of candidate cells or candidate frequencies by applying the at least one priority offset to at least one cell re-selection priority of the at least one frequency or at least one neighbor cell applying the WUS. For example, the UE supporting WUS may increase an absolute priority value of a frequency by one, two, etc. when the frequency also supports WUS. In this case, the priority for a frequency that supports the WUS could be different for the UEs supporting WUS and not supporting WUS.

In some example embodiments, the assistance information may be associated with at least one offset value for ranking the at least one frequency or the at least one neighbor cell applying the WUS, and the at least one offset value comprises at least one of the following: at least one offset associated with RSRP, or at least one offset associated with RSRQ, or at least one offset associated with SINR, etc.

In some example embodiments, the cell re-selection information may indicate a cell quality threshold, and the assistance information may be associated with at least one offset value for determining a target cell quality threshold for cell re-selection. For example, the first device 110 may determine the target cell quality threshold by increasing the cell quality threshold by the at least one offset value. Alternatively, in some other examples, the first device 110 may determine the target cell quality threshold by decreasing the cell quality threshold by the at least one offset value by the at least one offset value.

In some example embodiments, the assistance information may be associated with at least one offset value for determining a target cell quality for cell re-selection. For example, the first device 110 may determine whether a target cell quality for cell re-selection is better than a measured cell quality by the at least one offset value. Alternatively, in some other examples, the first device 110 may determine whether the target cell quality is worse than the measured cell quality by the at least one offset value.

In some example embodiments, the assistance information may indicate at least one of the following: an offset value specific to a frequency or neighbor cell applying the WUS, or an offset value common for the at least one frequency or the at least one neighbor cell applying the WUS.

In some example embodiments, the at least one offset value may be predetermined at the first device 110 and the second device 120. For example, the at least one offset value may be preconfigured by the second device 120, or alternatively, specified in relevant standards. Accordingly, the first device 110 may determine that the at least one frequency or the at least one neighbor cell applying the WUS based on the assistance information. Based on determining that the at least one frequency or the at least one neighbor cell applying the WUS, the first device 110 may apply the at least one offset value for cell re-selection.

In some example embodiments where the first device 110 supports the WUS, and the source cell 102 applies the WUS, the first device 110 may determine that a first threshold for triggering the cell re-selection evaluation is reached. Based on determining that the first threshold is reached, the first device 110 may perform the cell re-selection evaluation. In this case, the first threshold is different from a second threshold for cell re-selection that is assigned for a device 112 not supporting the WUS.

In some example embodiments, the assistance information may correspond to a device type of the first device 110. For example, the device type may comprise one of a RedCap device, or a non-RedCap device.

In some example embodiments, one of the first device 110 or the second device 120 may comprise a terminal device (e.g., UE), and the other one of the first device 110 or the second device 120 may comprise a network device (e.g., gNB).

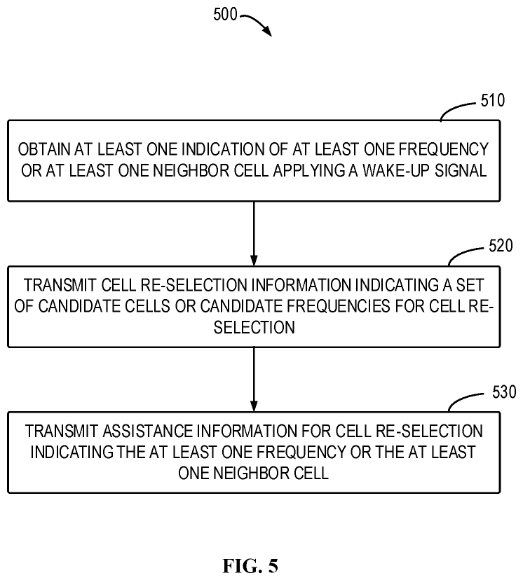

FIG. 5 illustrates a flowchart of an example method 500 according to some example embodiments of the present disclosure. The method 500 can be implemented at a network device, for example, the second device 120 described with reference to FIG. 1. For the purpose of discussion, the method 500 will be described with reference to FIG. 1. However, in some other embodiments, the method 500 can also be implemented at any other device. Therefore, the scope of the present disclosure is not limited in this regard.

At 510, the second device 120 obtains at least one indication of at least one frequency or at least one neighbor cell applying a WUS.

In some example embodiments, the at least one indication may be obtained from at least one third device providing the at least one neighbor cell or operating at the at least one frequency. In the example of FIG. 1, the third device 122 that provides the neighbor cell 104 supporting WUS may transmit such an indication.

At 520, the second device 120 transmits, to a first device 110 in a source cell 102 provided by the second device 120, cell re-selection information indicating a set of candidate cells or candidate frequencies for cell re-selection. In the example of FIG. 1, the candidate cells may include cells 104 and 106, and candidate frequencies may include at least one frequency at which cells 104 and 106 operate.

At 530, the second device 120 transmits, to the first device 110, assistance information for cell re-selection. In this case, the assistance information may indicate the at least one frequency or the at least one neighbor cell, and the set of candidate cells or candidate frequencies comprises at least one neighbor cell or the at least one frequency.

In some example embodiments, the assistance information may be carried via at least one of the following: a SIB or a RRC message, such as a RRC release message. For example, an existing SIB may be reused for carrying the assistance information. For another example, a new SIB may be used for specifically carrying the assistance information. Therefore, the scope of the present disclosure is not limited in this regard.

In some example embodiments, the assistance information may comprise at least one of the following: a cell list comprising the at least one cell applying the WUS, or a frequency list comprising the at least one frequency applying the WUS.

In some example embodiments, the cell re-selection information may be carried in an SIB. Additionally, or alternatively, the assistance information may be carried in a RRC message. In other words, the cell re-selection information may be broadcast by the gNB, while the assistance information may be provided to UE via dedicated signaling.

In some example embodiments, information carried via the RRC message may be prioritized over information carried via the SIB. In this case, the first device 110 may determine the priorities of the set of candidate cells or candidate frequencies based on the assistance information while ignoring the information carried in the SIB.

Alternatively, in some example embodiments, information carried via the SIB may be prioritized over information carried via the RRC message. In this case, the first device 110 may determine the priorities of the set of candidate cells or candidate frequencies based on the cell re-selection information, while ignoring the information carried in the RRC message.

In some example embodiments, the assistance information may be associated with at least one PLMN. That is, the gNB may provide different assistance information to UEs associated with different PLMN.

In some example embodiments, the cell re-selection information may indicate a set of cell re-selection priorities assigned for a device not supporting the WUS, and the assistance information may indicate at least one cell re-selection priority assigned for at least one frequency or the at least one neighbor cell applying the WUS.

In some example embodiments, the cell re-selection information may indicate a set of cell re-selection priorities of the set of candidate cells or candidate frequencies, and the assistance information may indicate at least one priority offset of the at least one frequency or at least one neighbor cell applying the WUS.

In some example embodiments, the assistance information may be associated with at least one offset value for ranking the at least one frequency or the at least one neighbor cell applying the WUS, and the at least one offset value comprises at least one of the following: at least one offset associated with RSRP, or at least one offset associated with RSRQ, or at least one offset associated with SINR, etc.

In some example embodiments, the cell re-selection information may indicate a cell quality threshold, and the assistance information may be associated with at least one offset value for determining a target cell quality threshold for cell re-selection.

In some example embodiments, the assistance information is associated with at least one offset value for determining a target cell quality for cell re-selection.

In some example embodiments, the assistance information may indicate at least one of the following: an offset value specific to a frequency or neighbor cell applying the WUS, or an offset value common for the at least one frequency or the at least one neighbor cell applying the WUS.

In some example embodiments, the at least one offset value may be predetermined at the first device 110 and the second device 120. For example, the at least one offset value may be preconfigured by the second device 120, or alternatively, specified in relevant standards. In this way, the UE may determine that the at least one frequency or the at least one neighbor cell applying the WUS based on the assistance information. The UE may then apply the at least one offset value for cell re-selection.

In some example embodiments, the assistance information may correspond to a device type of the first device 110. For example, the device type may comprise one of a RedCap device, or a non-RedCap device. In this case, the gNB may provide different assistance information to different types of UEs.

In some example embodiments, one of the first device 110 or the second device 120 may comprise a terminal device (e.g., UE), and the other one of the first device 110 or the second device 120 may comprise a network device (e.g., gNB).

According to the example embodiments, assistance information for cell re-selection is supported to be provided to UEs. Based on the assistance information, the UE supporting WUS is enabled to prioritize the cell or frequency that also supports WUS. In this way, a better energy efficiency can be achieved in UE. Furthermore, the assistance information may only have effects on the UE supporting WUS without impacting the UE not supporting WUS. By taking different link budgets for WUS into account, the mobility performance in RAN is ensured.

In some example embodiments, a first apparatus capable of performing the method 400 (for example, the first device 110) may comprise means for performing the respective steps of the method 400. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the first apparatus comprises: means for receiving, from a second apparatus providing a source cell for the first apparatus, cell re-selection information indicating a set of candidate cells or candidate frequencies for cell re-selection; means for receiving, from the second apparatus, assistance information for cell re-selection, the assistance information indicating at least one frequency or at least one neighbor cell applying a wake-up signal, the set of candidate cells or candidate frequencies comprising at least one neighbor cell or the at least one frequency; and means for performing, based on the cell re-selection information and the assistance information, a cell re-selection evaluation on at least a part of the set of candidate cells or candidate frequencies.

In some example embodiments, the assistance information is carried via at least one of the following: a system information block, or a radio resource control message.

In some example embodiments, the assistance information comprises at least one of the following: a cell list comprising the at least one cell applying the wake-up signal, or a frequency list comprising the at least one frequency applying the wake-up signal.

In some example embodiments, the cell re-selection information is carried in a system information block, and the assistance information is carried in a radio resource control message.

In some example embodiments, the means for performing the cell-re-selection evaluation on at least a part of the set of candidate cells or candidate frequencies comprises: means for determining that information carried via the radio resource control message is prioritized over information carried via the system information block; and means for based on determining that the information carried via the radio resource control message is prioritized over the information carried via the system information block, performing the cell re-selection evaluation based on the assistance information.

In some example embodiments, the means for performing the cell-re-selection evaluation on at least a part of the set of candidate cells or candidate frequencies comprises: means for determining that information carried via the system information block is prioritized over information carried via the radio resource control message; and means for based on determining that the information carried via the system information block is prioritized over the information carried via the radio resource control message, performing the cell re-selection evaluation based on the cell re-selection information.

In some example embodiments, the means for performing the cell-re-selection evaluation on at least a part of the set of candidate cells or candidate frequencies comprises: means for determining that the source cell was a primary cell before the first apparatus was directed to a radio resource control inactive mode or a radio resource control idle mode; and means for based on determining that the source cell was the primary cell, performing the cell re-selection evaluation based on the assistance information.

In some example embodiments, the means for performing the cell-re-selection evaluation on at least a part of the set of candidate cells or candidate frequencies comprises: means for determining that the source cell was a cell other than a primary cell; and means for based on determining that the source cell was the cell other than the primary cell, performing the cell re-selection evaluation based on the cell re-selection information.

In some example embodiments, the assistance information is associated with at least one public land mobile network.

In some example embodiments, the first apparatus further comprises: means for determining, based on at least one of the cell re-selection information and the assistance information, priorities of the set of candidate cells or candidate frequencies.

In some example embodiments, the means for determining the priorities of the set of candidate cells or candidate frequencies comprises: means for ranking the at least one frequency or the at least one neighbor cell applying the wake-up signal with a higher priority than a rest of the set of candidate cells or candidate frequencies not applying the wake-up signal.

In some example embodiments, the cell re-selection information indicates a set of cell re-selection priorities assigned for a device not supporting the wake-up signal, and the assistance information indicates at least one cell re-selection priority assigned for at least one frequency or the at least one neighbor cell applying the wake-up signal.

In some example embodiments, the means for determining the priorities of the set of candidate cells or candidate frequencies comprises: means for determining that the first apparatus supports the wake-up signal; and means for based on determining that the first apparatus supports the wake-up signal, determining the priorities of the set of candidate cells or candidate frequencies based on the cell re-selection information.

In some example embodiments, the cell re-selection information indicates a set of cell re-selection priorities of the set of candidate cells or candidate frequencies, and the assistance information indicates at least one priority offset of the at least one frequency or at least one neighbor cell applying the wake-up signal.

In some example embodiments, the means for determining the priorities of the set of candidate cells or candidate frequencies comprises: means for determining that the first apparatus supports the wake-up signal; and means for based on determining that the first apparatus supports the wake-up signal, determining the priorities of the set of candidate cells or candidate frequencies by applying the at least one priority offset to at least one cell re-selection priority of the at least one frequency or the at least one neighbor cell applying the wake-up signal.

In some example embodiments, the assistance information is associated with at least one offset value for ranking the at least one frequency or the at least one neighbor cell applying the wake-up signal, and the at least one offset value comprises at least one of the following: at least one offset associated with Reference Signal Received Power, or at least one offset associated with Reference Signal Received Quality, or at least one offset associated with Signal to Interference plus Noise Ratio.

In some example embodiments, the cell re-selection information indicates a cell quality threshold, and the assistance information is associated with at least one offset value for determining a target cell quality threshold for cell re-selection, and the means for performing the cell re-selection evaluation comprises one of the following: means for determining the target cell quality threshold by increasing the cell quality threshold by the at least one offset value; or means for determining the target cell quality threshold by decreasing the cell quality threshold by the at least one offset value by the at least one offset value.

In some example embodiments, the assistance information is associated with at least one offset value for determining a target cell quality for cell re-selection, and the means for performing the cell re-selection evaluation comprises one of the following: means for determining whether a target cell quality for cell re-selection is better than a measured cell quality by the at least one offset value; or means for determining whether the target cell quality is worse than the measured cell quality by the at least one offset value.

In some example embodiments, the assistance information indicates at least one of the following: an offset value specific to a frequency or neighbor cell applying the wake-up signal, or an offset value common for the at least one frequency or the at least one neighbor cell applying the wake-up signal.

In some example embodiments, the at least one offset value is predetermined at the first apparatus and the second apparatus, and the means for performing the cell re-selection evaluation comprises: means for determining that the at least one frequency or the at least one neighbor cell applying the wake-up signal based on the assistance information; and means for based on determining that the at least one frequency or the at least one neighbor cell applying the wake-up signal, apply the at least one offset value for cell re-selection.

In some example embodiments, the first apparatus supports the wake-up signal, and the source cell applies the wake-up signal, and the means for performing the cell re-selection evaluation comprises: means for determining that a first threshold for triggering the cell re-selection evaluation is reached; and means for based on determining that the first threshold is reached, performing the cell re-selection evaluation, the first threshold being different from a second threshold for cell re-selection that is assigned for a device not supporting the wake-up signal.

In some example embodiments, the assistance information corresponds to a device type of the first apparatus, and the device type comprises one of a reduced capability device, or a non-reduced capability device.

In some example embodiments, one of the first and second apparatuses comprises a terminal device, and the other one of the first and second apparatuses comprises a network device.

In some example embodiments, a second apparatus capable of performing the method 500 (for example, the second device 120) may comprise means for performing the respective steps of the method 500. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the second apparatus comprises: means for obtaining at least one indication of at least one frequency or at least one neighbor cell applying a wake-up signal; means for transmitting, to a first apparatus in a source cell provided by the second apparatus, cell re-selection information indicating a set of candidate cells or candidate frequencies for cell re-selection; and means for transmitting, to the first apparatus, assistance information for cell re-selection, the assistance information indicating the at least one frequency or the at least one neighbor cell, the set of candidate cells or candidate frequencies comprising at least one neighbor cell or the at least one frequency.

In some example embodiments, the at least one indication is obtained from at least one third apparatus providing the at least one neighbor cell or operating at the at least one frequency.

In some example embodiments, the assistance information is carried via at least one of the following: a system information block, or a radio resource control message.

In some example embodiments, the assistance information comprises at least one of the following: a cell list comprising the at least one cell applying the wake-up signal, or a frequency list comprising the at least one frequency applying the wake-up signal.

In some example embodiments, the cell re-selection information is carried in a system information block, and the assistance information is carried in a radio resource control message.

In some example embodiments, information carried via the radio resource control message is prioritized over information carried via the system information block.

In some example embodiments, information carried via the system information block is prioritized over information carried via the radio resource control message.

In some example embodiments, the assistance information is associated with at least one public land mobile network.

In some example embodiments, the cell re-selection information indicates a set of cell re-selection priorities assigned for a device not supporting the wake-up signal, and the assistance information indicates at least one cell re-selection priority assigned for at least one frequency or the at least one neighbor cell applying the wake-up signal.

In some example embodiments, the cell re-selection information indicates a set of cell re-selection priorities of the set of candidate cells or candidate frequencies, and the assistance information indicates at least one priority offset of the at least one frequency or at least one neighbor cell applying the wake-up signal.

In some example embodiments, the assistance information is associated with at least one offset value for ranking the at least one frequency or the at least one neighbor cell applying the wake-up signal, and the at least one offset value comprises at least one of the following: at least one offset associated with Reference Signal Received Power, or at least one offset associated with Reference Signal Received Quality, or at least one offset associated with Signal to Interference plus Noise Ratio.

In some example embodiments, the cell re-selection information indicates a cell quality threshold, and the assistance information is associated with at least one offset value for determining a target cell quality threshold for cell re-selection.

In some example embodiments, the assistance information is associated with at least one offset value for determining a target cell quality for cell re-selection.

In some example embodiments, the assistance information indicates at least one of the following: an offset value specific to a frequency or neighbor cell applying the wake-up signal, or an offset value common for the at least one frequency or the at least one neighbor cell applying the wake-up signal.

In some example embodiments, the at least one offset value is predetermined at the first apparatus and the second apparatus.

In some example embodiments, the assistance information corresponds to a device type of the first apparatus, and the device type comprises one of a reduced capability device, or a non-reduced capability device.

In some example embodiments, one of the first and second apparatuses comprises a terminal device, and the other one of the first and second apparatuses comprises a network device.

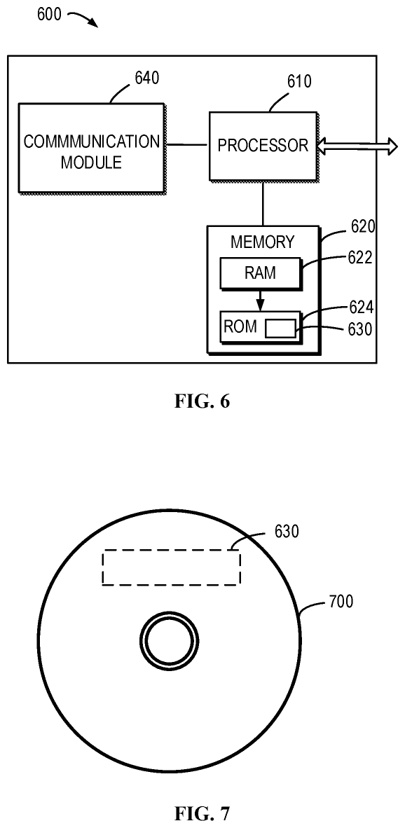

FIG. 6 is a simplified block diagram of a device 600 that is suitable for implementing embodiments of the present disclosure. The device 600 may be provided to implement the communication device, for example the first device 110 or the second device 120 as shown in FIG. 1. As shown, the device 600 includes one or more processors 610, one or more memories 620 coupled to the processor 610, and one or more transmitters and/or receivers (TX/RX) 640 (i.e., the communication module 640) coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a

Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIG. 2 to FIG. 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIG. 4 and FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-45. (canceled)

46. A first device, comprising:
at least one processor; and
at least one memory storing instructions that, when executed by the at least one processor, cause the first device at least to perform:
receiving, from a second device providing a source cell for the first device, cell re-selection information indicating a set of candidate cells or candidate frequencies for cell re-selection;
receiving, from the second device, assistance information for cell re-selection, the assistance information indicating at least one frequency or at least one neighbor cell applying a wake-up signal, the set of candidate cells or candidate frequencies comprising the at least one neighbor cell or the at least one frequency; and
performing, based on the cell re-selection information and the assistance information, a cell re-selection evaluation on at least a part of the set of candidate cells or candidate frequencies.

47. The first device of claim 46, wherein the assistance information is carried via at least one of the following:
a system information block, or
a radio resource control message.

48. The first device of claim 46, wherein the assistance information comprises at least one of the following:
a cell list comprising the at least one cell applying the wake-up signal, or
a frequency list comprising the at least one frequency applying the wake-up signal.

49. The first device of claim 46, wherein the cell re-selection information is carried in a system information block, and the assistance information is carried in a radio resource control message.

50. The first device of claim 49, wherein performing the cell-re-selection evaluation on at least a part of the set of candidate cells or candidate frequencies comprises:
determining that information carried via the radio resource control message is prioritized over information carried via the system information block; and
based on determining that the information carried via the radio resource control message is prioritized over the information carried via the system information block, performing the cell re-selection evaluation based on the assistance information.

51. The first device of claim 49, wherein performing the cell-re-selection evaluation on at least a part of the set of candidate cells or candidate frequencies comprises:
determining that information carried via the system information block is prioritized over information carried via the radio resource control message; and
based on determining that the information carried via the system information block is prioritized over the information carried via the radio resource control message, performing the cell re-selection evaluation based on the cell re-selection information.

52. The first device of claim 49, wherein performing the cell-re-selection evaluation on at least a part of the set of candidate cells or candidate frequencies comprises:
determining that the source cell was a primary cell before the first device was directed to a radio resource control inactive mode or a radio resource control idle mode; and
based on determining that the source cell was the primary cell, performing the cell re-selection evaluation based on the assistance information.

53. The first device of claim 49, wherein performing the cell-re-selection evaluation on at least a part of the set of candidate cells or candidate frequencies comprises:
determining that the source cell was a cell other than a primary cell; and
based on determining that the source cell was the cell other than the primary cell, performing the cell re-selection evaluation based on the cell re-selection information.

54. The first device of claim 46, wherein the at least one memory storing instructions that, when executed by the at least one processor, further cause the first device to perform:
determining, based on at least one of the cell re-selection information and the assistance information, priorities of the set of candidate cells or candidate frequencies.

55. The first device of claim 46, wherein the assistance information is associated with at least one offset value for ranking the at least one frequency or the at least one neighbor cell applying the wake-up signal, and the at least one offset value comprises at least one of the following:
at least one offset associated with Reference Signal Received Power, or
at least one offset associated with Reference Signal Received Quality, or
at least one offset associated with Signal to Interference plus Noise Ratio.

56. The first device of claim 46, wherein the cell re-selection information indicates a cell quality threshold, and the assistance information is associated with at least one offset value for determining a target cell quality threshold for cell re-selection, and
wherein performing the cell re-selection evaluation comprises one of the following:
determining the target cell quality threshold by increasing the cell quality threshold by the at least one offset value; or
determining the target cell quality threshold by decreasing the cell quality threshold by the at least one offset value by the at least one offset value.

57. The first device of claim 46, wherein the assistance information is associated with at least one offset value for determining a target cell quality for cell re-selection, and
wherein performing the cell re-selection evaluation comprises one of the following:
determining whether a target cell quality for cell re-selection is better than a measured cell quality by the at least one offset value; or
determining whether the target cell quality is worse than the measured cell quality by the at least one offset value.

58. The first device of claim 46, wherein the first device supports the wake-up signal, and the source cell applies the wake-up signal, and
wherein performing the cell re-selection evaluation comprises:
determining that a first threshold for triggering the cell re-selection evaluation is reached; and
based on determining that the first threshold is reached, performing the cell re-selection evaluation, the first threshold being different from a second threshold for cell re-selection that is assigned for a device not supporting the wake-up signal.

59. A second device, comprising:
at least one processor; and
at least one memory storing instructions that, when executed by the at least one processor, cause the second device at least to perform:
obtaining at least one indication of at least one frequency or at least one neighbor cell applying a wake-up signal;
transmitting, to a first device in a source cell provided by the second device, cell re-selection information indicating a set of candidate cells or candidate frequencies for cell re-selection; and
transmitting, to the first device, assistance information for cell re-selection, the assistance information indicating the at least one frequency or the at least one neighbor cell, the set of candidate cells or candidate frequencies comprising at least one neighbor cell or the at least one frequency.

60. The second device of claim 59, wherein the at least one indication is obtained from at least one third device providing the at least one neighbor cell or operating at the at least one frequency.

61. The second device of claim 59, wherein the assistance information is carried via at least one of the following:
a system information block, or
a radio resource control message.

62. The second device of claim 59, wherein the assistance information comprises at least one of the following:
a cell list comprising the at least one cell applying the wake-up signal, or
a frequency list comprising the at least one frequency applying the wake-up signal.

63. The second device of claim 59, wherein the cell re-selection information is carried in a system information block, and the assistance information is carried in a radio resource control message.

64. The second device of claim 59, wherein the cell re-selection information indicates a set of cell re-selection priorities assigned for a device not supporting the wake-up signal, and the assistance information indicates at least one cell re-selection priority assigned for at least one frequency or the at least one neighbor cell applying the wake-up signal.

65. A method comprising:
receiving, at a first device and from a second device providing a source cell for the first device, cell re-selection information indicating a set of candidate cells or candidate frequencies for cell re-selection;
receiving, from the second device, assistance information for cell re-selection, the assistance information indicating at least one frequency or at least one neighbor cell applying a wake-up signal, the set of candidate cells or candidate frequencies comprising at least one neighbor cell or the at least one frequency; and
performing, based on the cell re-selection information and the assistance information, a cell re-selection evaluation on at least a part of the set of candidate cells or candidate frequencies.
